(19) United States
(12) Patent Application Publication
(10) Pub. No.: US 2014/0285484 A1
(43) Pub. Date: Sep. 25, 2014

(54) SYSTEM OF PROVIDING STEREOSCOPIC IMAGE TO MULTIPLE USERS AND METHOD THEREOF

(71) Applicant: Electronics & Telecommunications Research Institute, Daejeon (KR)

(72) Inventors: Yong Wan KIM, Daejeon (KR); Dong Sik Jo, Daejeon (KR); Ung Yeon Yang, Daejeon (KR); Ki Hong Kim, Daejeon (KR); Gil Haeng Lee, Seoul (KR)

(73) Assignee: Electronics & Telecommunications Research Institute, Daejeon (KR)

(21) Appl. No.: 14/217,906

(22) Filed: Mar. 18, 2014

(30) Foreign Application Priority Data
Mar. 21, 2013 (KR) 10-2013-0030433

(51) Int. Cl. H04N 13/04; G06T 19/00; G06T 15/00

(52) U.S. Cl. CPC H04N 13/047; G06T 15/00; G06T 19/006; H04N 13/0429
USPC 345/419

(57) ABSTRACT

Provided are a system and method of simultaneously providing stereoscopic images to multiple users. The system includes at least one glasses unit, a stereoscopic image generating device configured to calculate spatial information of the at least one glasses unit, and generate the stereoscopic image corresponding to the spatial information of the at least one glasses unit, and a stereoscopic image providing device configured to project the stereoscopic image corresponding to the spatial information of the at least one glasses unit to provide the projected stereoscopic image to the at least one glasses unit. Thus, through lightweight glasses constituted of only simple optical elements without a separate electronic device such as a micro panel, stereoscopic information such as through an existing HMD may be provided to multiple users.

### CLAIM FOR PRIORITY

This application claims priority to Korean Patent Application No. 10-2013-0030433 filed on Mar. 21, 2013 in the Korean Intellectual Property Office (KIPO), the entire contents of which are hereby incorporated by reference.

### BACKGROUND

1. Technical Field

Example embodiments of the present invention relate in general to providing of a stereoscopic image, and more specifically, to a system and method of simultaneously providing stereoscopic images to multiple users.

2. Related Art

As next-generation image display technologies that can replace an existing image display apparatus, multi-view display technologies focusing on stereopsis and ultra-high definition (UHD) display technologies focusing on an increase in realism and immersion due to an increase in screen resolution have been actively discussed.

However, with regard to the multi-view display technologies, many technologies for reproducing three-dimensional (3D) images have been recently studied, but stereoscopic 3D technology that has been commercially available as representative 3D technology has technical limitations in that it requires wearing of special glasses at the time of viewing or it causes users various inconveniences such as eye fatigue.

In addition, studies on virtual reality technologies for providing a feeling of reality to users in an artificial space created using a device such as a computer so that environments which human beings cannot experience in the real world are created using the computer so that the users can experience them as if they were real are being actively conducted.

For example, a head mounted display (HMD) is a video device which is provided in the form of goggles or a helmet and through which a screen in front of a user's eyes is viewed. The HMD has been developed primarily to realize virtual reality, and in the HMD, a small display such as a liquid crystal is installed close to both eyes and stereoscopic images using parallax are projected onto the small device.

That is, immersive enhanced scenes may be created and provided through the HMD or the like so as to make users feel like they are in an arbitrary space different from a space in which the user is presently located.

However, since the HMD is complex due to a micro panel and a plurality of lenses included in the HMD and expensive, it is difficult for more than a small number of users such as in exhibitions, theme parks, and the like to use the HMD.

### SUMMARY

Accordingly, example embodiments of the present invention are provided to substantially obviate one or more problems due to limitations and disadvantages of the related art.

Example embodiments of the present invention provide a system of efficiently providing stereoscopic images and augmented reality to multiple users.

Example embodiments of the present invention also provide a method of efficiently providing stereoscopic images and augmented reality to multiple users.

In some example embodiments, a system of providing a stereoscopic image to multiple users, includes: at least one glasses unit; a stereoscopic image generating device configured to calculate spatial information of the at least one glasses unit, and generate the stereoscopic image corresponding to the spatial information of the at least one glasses unit; and a stereoscopic image providing device configured to project the stereoscopic image corresponding to the spatial information of the at least one glasses unit to provide the projected stereoscopic image to the at least one glasses unit.

Here, the at least one glasses unit may include a semi-transmission mirror that semi-transmits and reflects the projected stereoscopic image, and a polarization filter that is mounted in a front surface of the semi-transmission mirror to reproduce a three-dimensional (3D) image.

Also, the at least one glasses unit may generate information about a position or a direction of the at least one glasses unit using at least one of an acceleration sensor, a gyroscope sensor, a geomagnetic sensor, a depth map sensor, and an optical marker sensor to provide the generated information to the stereoscopic image generating device.

Also, the stereoscopic image generating device may include a glasses tracking unit that calculates the spatial information of the at least one glasses unit using information about a position or a direction of the at least one glasses unit, and a parameter extraction unit that extracts a projection parameter for generating the stereoscopic image corresponding to the spatial information of the at least one glasses unit.

Also, the glasses tracking unit may calculate the spatial information of the at least one glasses unit using an infrared camera or a depth camera.

Also, the stereoscopic image generating device may include a stereoscopic image generating unit that generates the stereoscopic image corresponding to the spatial information of the at least one glasses unit using the projection parameter, and a distortion correction unit that corrects image distortion that occurs in accordance with the spatial information of the at least one glasses unit.

Also, the stereoscopic image providing device may include a projector that projects the stereoscopic image corresponding to the spatial information of the at least one glasses unit, and a display device that implements a 3D image.

Also, the stereoscopic image generating device may further include a calibration unit that adjusts the stereoscopic image corresponding to the spatial information of the at least one glasses unit so as to match images between at least two of the at least one glasses unit, the projector, and the display device that implements the 3D image.

In other example embodiments, a stereoscopic image generating device that provides a stereoscopic image to multiple users, includes: a glasses tracking unit configured to extract information about a position or a direction of at least one glasses unit to calculate spatial information of the at least one glasses unit; a parameter extraction unit configured to extract a projection parameter for generating the stereoscopic image corresponding to the spatial information of the at least one glasses unit; and a stereoscopic image generating unit configured to generate the stereoscopic image corresponding to the spatial information of the at least one glasses unit using the projection parameter.

Here, the stereoscopic image generating device may further include a distortion correction unit configured to correct image distortion that occurs in accordance with the spatial information of the at least one glasses unit.

Also, the at least one glasses unit may include a semi-transmission mirror that semi-transmits and reflects a projected stereoscopic image, and a polarization filter that is mounted in a front surface of the semi-transmission mirror to reproduce a 3D image.

Also, the stereoscopic image generating device may transmit the stereoscopic image corresponding to the spatial information of the at least one glasses unit to a projector so that the transmitted stereoscopic image is projected.

In still other example embodiments, a method of providing a stereoscopic image to multiple users, includes: extracting information about a position or a direction of at least one glasses unit which is worn by a user to calculate spatial information of the at least one glasses unit; generating the stereoscopic image corresponding to the spatial information of the at least one glasses unit; and projecting the stereoscopic image corresponding to the spatial information of the at least one glasses unit to provide the projected stereoscopic image to the at least one glasses unit.

Here, the at least one glasses unit may include a semi-transmission mirror that semi-transmits and reflects the projected stereoscopic image, and a polarization filter that is mounted in a front surface of the semi-transmission mirror to reproduce a 3D image.

Also, the extracting of the information may include extracting the information about the position or the direction of the at least one glasses unit using at least one of an acceleration sensor, a gyroscope sensor, a geomagnetic sensor, a depth map sensor, and an optical marker sensor which are mounted in the at least one glasses unit.

Also, the extracting of the information may include calculating the spatial information of the at least one glasses unit using an infrared camera or a depth camera.

Also, the generating of the stereoscopic image may include extracting a projection parameter for generating the stereoscopic image corresponding to the spatial information of the at least one glasses unit, generating the stereoscopic image corresponding to the spatial information of the at least one glasses unit using the projection parameter, and correcting image distortion that occurs in accordance with the spatial information of the at least one glasses unit.

Also, the projecting of the stereoscopic image may include projecting the stereoscopic image corresponding to the spatial information of the at least one glasses unit using a projector, and providing a 3D image using a display device that implements the 3D image while projecting the stereoscopic image corresponding to the spatial information of the at least one glasses unit using the projector.

Also, the generating of the stereoscopic image may further include adjusting the stereoscopic image corresponding to the spatial information of the at least one glasses unit so as to match images between at least two of the at least one glasses unit, the projector, and the display device that implements the 3D image.

Also, the projector may be a short focus projector.

### BRIEF DESCRIPTION OF DRAWINGS

Example embodiments of the present invention will become more apparent by describing in detail example embodiments of the present invention with reference to the accompanying drawings, in which:

FIG. 1 is a block diagram showing a configuration of a system of providing stereoscopic images to multiple users according to an embodiment of the present invention;

FIG. 2 is a view showing a configuration of a glasses unit according to an embodiment of the present invention;

FIG. 3 is a block diagram showing a configuration of a stereoscopic image generating device according to an embodiment of the present invention;

FIG. 4 is a block diagram showing a configuration of a stereoscopic image providing device according to an embodiment of the present invention;

FIG. 5 is a conceptual diagram showing a method of providing stereoscopic images to multiple users according to an embodiment of the present invention;

FIG. 6 is a flowchart showing a method of providing stereoscopic images to multiple users according to an embodiment of the present invention; and

FIG. 7 is a flowchart showing a method of generating stereoscopic images according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and example embodiments of the present invention may be embodied in many alternate forms and should not be construed as being limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings.

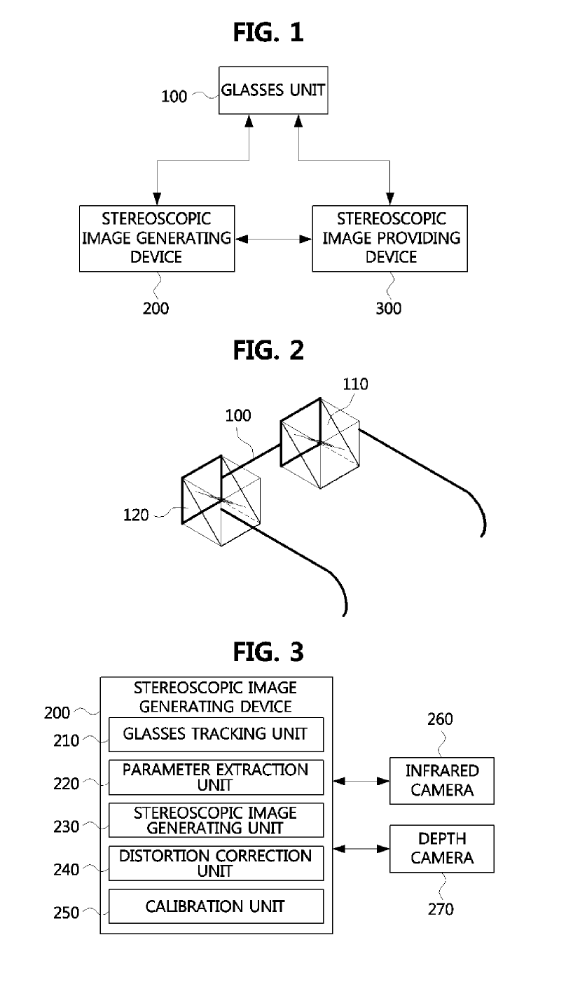

FIG. 1 is a block diagram showing a configuration of a system of providing stereoscopic images to multiple users according to an embodiment of the present invention.

Referring to FIG. 1, the system of providing the stereoscopic images to the multiple users according to an embodiment of the present invention includes a glasses unit 100, a stereoscopic image generating device 200, and a stereoscopic image providing device 300.

In the system of providing the stereoscopic image to the multiple users, the glasses unit 100, the stereoscopic image generating device 200, and the stereoscopic image providing device 300 are operated in conjunction with each other, thereby providing stereoscopic images or augmented reality to the multiple users.

The glasses unit 100 may provide a stereoscopic image projected by a projector 310 to a user's eyes, and the stereoscopic image providing device 300 may generate the stereoscopic image based on a position or a direction of the glasses unit 100.

In addition, the stereoscopic image providing device 300 may project the stereoscopic image generated in the stereoscopic image generating device 200.

For example, the glasses unit 100 may have the form of common glasses which can be worn by a user, but a semi-transmission mirror 110 may be mounted in the glasses unit 100 so that the projected stereoscopic image may effectively reach the user's eyes.

In addition, the glasses unit 100 may selectively utilize various types of sensors that can obtain information about a position and a direction of the glasses unit 100.

The stereoscopic image generating device 200 may be an image processing device that generates a stereoscopic image. The stereoscopic image generating device 200 may generate the stereoscopic image and transmit the generated stereoscopic image to the stereoscopic image providing device 300.

In particular, the stereoscopic image generating device 200 may generate the stereoscopic images so that different stereoscopic images can be viewed in accordance with positions or directions in which multiple users view the images.

Accordingly, the stereoscopic image generating device 200 may utilize the information about the position or the direction of the glasses unit 100 obtained by the glasses unit 100 when generating the stereoscopic images.

The stereoscopic image providing device 300 may provide the stereoscopic images generated in the stereoscopic image generating device 200 to the glasses unit 100.

The stereoscopic image providing device 300 may project the stereoscopic image to provide the projected stereoscopic image to the glasses unit 100. For example, the stereoscopic image providing device 300 may project the stereoscopic image to the glasses unit 100 using the projector 310.

In addition, the stereoscopic image providing device 300 may include a display device 320 that implements three-dimensional (3D) images. For example, the user may view the display device 320 that implements the 3D images while viewing the stereoscopic image projected through the projector 310 using the glasses unit 100. That is, the user may view an image in which the stereoscopic image projected to an image provided by the display device 320 through the projector 310 is augmented.

FIG. 2 is a view showing a configuration of a glasses unit according to an embodiment of the present invention.

Referring to FIG. 2, the glasses unit 100 which can be worn by a user may provide stereoscopic images or augmented reality to eyes of the user.

The glasses unit 100 may include a semi-transmission mirror 110 that semi-transmits and reflects a stereoscopic image projected by the projector 310 and provides the semi-transmitted and reflected stereoscopic image to the user's eyes, and a polarization filter 120 is mounted in a front surface of the semi-transmission mirror 110 so that the display device 320 implementing 3D images may be viewed.

Here, the semi-transmission mirror 110 may change a direction of the stereoscopic image projected by the projector and transmit the stereoscopic image to the user's eyes. Accordingly, the semi-transmission mirror 110 may reflect the stereoscopic image projected by the projector 310 at a predetermined angle.

In addition, the glasses unit 100 may include various types of sensors that can obtain information about a position or a direction of the glasses unit 100. That is, spatial information of the glasses unit 100 may be calculated through the information about the position or the direction of the glasses unit 100. Here, the spatial information of the glasses unit 100 may refer to information about a position or a direction in which a user views an image through the glasses unit 100.

For example, the glasses unit 100 may obtain the information about the position or the direction of the glasses unit 100 using an acceleration sensor, a gyroscope sensor, a geomagnetic sensor, a depth map sensor, or an optical marker sensor.

Accordingly, the acceleration sensor, the gyroscope sensor, the geomagnetic sensor, the depth map sensor, or the optical marker sensor may be mounted in the glasses unit 100.

However, according to an embodiment of the present invention, types and the number of sensors which are mounted in the glasses unit 100 are not particularly limited.

Thus, the glasses unit 100 may obtain the information about the position or the direction of the glasses unit 100 and provide the obtained information to the stereoscopic image generating device 200.

FIG. 3 is a block diagram showing a configuration of a stereoscopic image generating device according to an embodiment of the present invention.

Referring to FIG. 3, the stereoscopic image generating device 200 according to an embodiment of the present invention includes a glasses tracking unit 210, a parameter extraction unit 220, and a stereoscopic image generating unit 230.

The stereoscopic image generating device 200 may calculate spatial information of the glasses unit 100 through information about a position or a direction of the glasses unit 100, and generate a stereoscopic image corresponding to the spatial information of the glasses unit 100.

The glasses tracking unit 210 may calculate the spatial information of the glasses unit 100 using the information about the position or the direction of the glasses unit 100. That is, the glasses tracking unit 210 may receive the information about the position or the direction of the glasses unit 100 obtained through various types of sensors mounted in the glasses unit 100, thereby recognizing the spatial information of the glasses unit 100.

In addition, the glasses tracking unit 210 may calculate the spatial information of the glasses unit 100 in conjunction with an infrared camera 260 or a depth camera 270. Here, the spatial information of the glasses unit 100 may refer to information about a position or a direction in which a user views an image through the glasses unit 100.

The parameter extraction unit 220 may extract a projection parameter for generating a stereoscopic image corresponding to the spatial information of the glasses unit 100.

The parameter extraction unit 220 may extract the projection parameter that enables the stereoscopic image to be rendered in accordance with the spatial information of the glasses unit 100. That is, the projection parameter may be a parameter that enables the projected stereoscopic image to be rendered differently for each region in accordance with the spatial information of the glasses unit 100.

The stereoscopic image generating unit 230 may generate a stereoscopic image corresponding to the spatial information of the glasses unit 100 based on binocular disparity using the projection parameter.

The stereoscopic image generating unit 230 may generate the stereoscopic image by rendering the image using the projection parameter received from the parameter extraction unit 220. Accordingly, the stereoscopic image generating unit 230 may generate the stereoscopic images that are rendered differently for each region in accordance with the spatial information of the glasses unit 100.

The stereoscopic image generating device 200 according to an embodiment of the present invention may further include a distortion correction unit 240 and a calibration unit 250.

The distortion correction unit 240 may correct image distortion that occurs in accordance with the spatial information of the glasses unit 100. That is, distortion of an image may occur in a process of rendering the image using the projection parameter, and the distortion correction unit 240 may correct such distortion of the image. For example, the distortion correction unit 240 may correct the image through shader-based image warping.

The calibration unit 250 may adjust the stereoscopic image corresponding to the spatial information of the glasses unit 100 so as to match images between at least two of the glasses unit 100, the projector 310, and the display device 320 that implements the 3D image.

The stereoscopic image projected from the projector 310 may be transmitted to the user's eyes through the glasses unit 100, and the image provided by the display device 320 implementing the 3D image may be also provided to the user's eyes through the glasses unit 100.

Accordingly, the stereoscopic images may be adjusted so that images are matched between the user's eyes and the glasses unit 100, between the glasses unit 100 and the projector 310, and between the glasses unit 100 and the display device 320.

The respective components of the stereoscopic image generating device 200 according to an embodiment of the present invention have been arranged and described for convenience of description, but at least two of the respective components may be integrated as a single component, or a single component may be divided into a plurality of components to perform corresponding functions. Even a case in which each component is integrated or divided may be included in the scope of the present invention as long as it does not depart from the nature of the present invention.

In addition, operations of the stereoscopic image generating device 200 according to the embodiments of the present invention may be implemented in a computer-readable recording medium as a computer-readable program or code.

The computer-readable recording medium includes all types of recording devices in which data readable by a computer system is stored. In addition, the computer-readable recording medium may be distributed in a computer system connected via a network, so that the computer-readable program or code may be stored and executed in a distribution method.

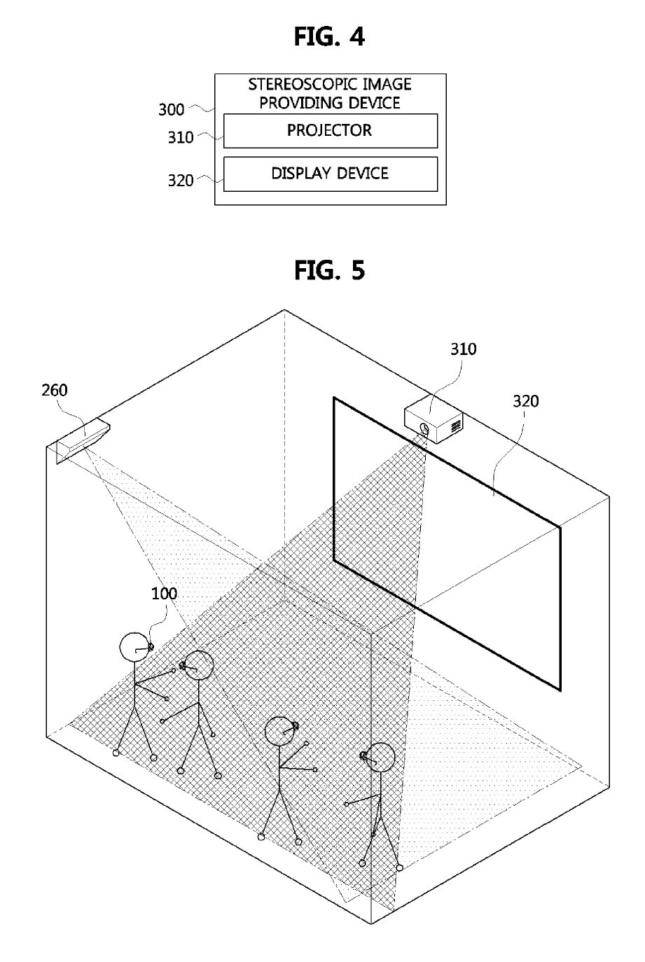

FIG. 4 is a block diagram showing a configuration of a stereoscopic image providing device according to an embodiment of the present invention.

Referring to FIG. 4, the stereoscopic image providing device 300 according to an embodiment of the present invention may include the projector 310, and further include the display device 320 that implements 3D images.

The projector 310 may project the stereoscopic image generated by the stereoscopic image generating device 200 to the glasses unit 100. That is, the projector 310 may provide, to a plurality of glasses units 100, the stereoscopic images which have been generated and corrected in the stereoscopic image generating device 200.

FIG. 5 is a conceptual diagram showing a method of providing stereoscopic images to multiple users according to an embodiment of the present invention.

Referring to FIG. 5, multiple users may gather at an exhibition or a theme park.

The projector 310 may be installed in a ceiling of the exhibition or the theme park in which the multiple users wearing the glasses unit are gathered, and project stereoscopic images, thereby providing stereoscopic images or augmented reality to the multiple users.

For example, the stereoscopic image projected from the projector 310 installed in the ceiling may be transmitted to the users' eyes through the semi-transmission mirror 110. Thus, it is possible to efficiently provide the stereoscopic images to the multiple users using the projector 310 installed in the ceiling.

However, according to an embodiment of the present invention, the projector 310 is not limitedly installed only in the ceiling but, obviously, the projector 310 may be installed in a variety of positions in which the stereoscopic images can be projected to multiple users to be provided.

In addition, the projector 310 may be utilized simultaneously with the display device 320 that implements the 3D images. That is, according to an embodiment of the present invention, the stereoscopic image corresponding to the spatial information of the glasses unit 100 may be projected using the projector 310, and at the same time, the 3D image may be provided to multiple users using the display device 320.

For example, the projector 310 installed in the ceiling may project the stereoscopic image nearly in a vertical direction with respect to a surface of the ceiling, and the display device 320 may be installed in front of a user to provide 3D images.

Thus, the user may be efficiently provided with the stereoscopic images provided in mutually different directions.

Meanwhile, the infrared camera 260 or the depth camera 270 may be installed at an exhibition or a theme park to calculate spatial information of the glasses unit 100.

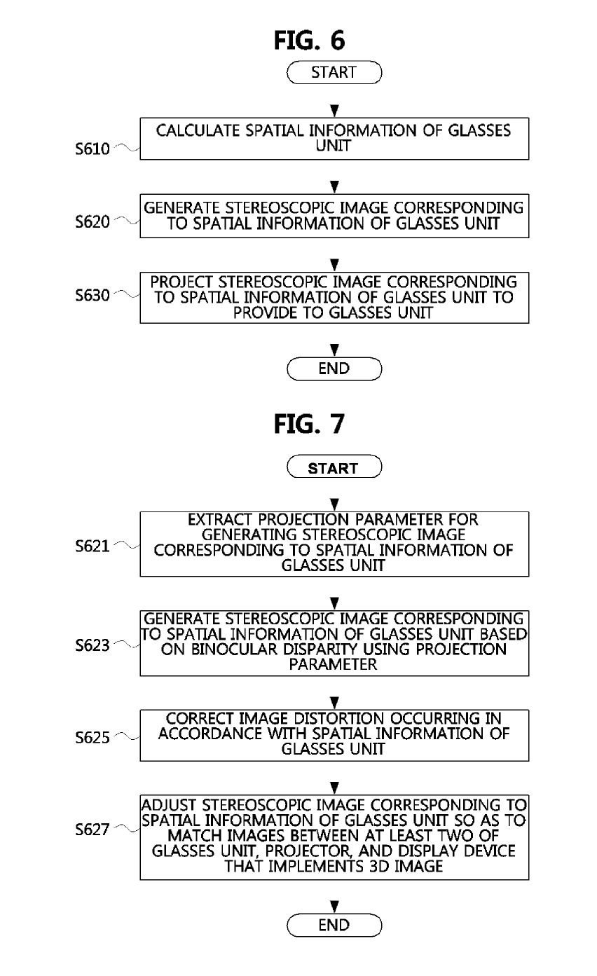

FIG. 6 is a flowchart showing a method of providing stereoscopic images to multiple users according to an embodiment of the present invention.

The method according to an embodiment of the present invention may be implemented using the above-described system of providing the stereoscopic image to the multiple users. Accordingly, with reference to the above-described system of providing the stereoscopic image to the multiple users, the method according to an embodiment of the present invention can be more clearly understood.

Referring to FIG. 6, the method of providing the stereoscopic image to the multiple users according to an embodiment of the present invention includes step S610 of calculating spatial information of the glasses unit 100, step S620 of generating a stereoscopic image corresponding to the spatial information of the glasses unit 100, and step S630 of projecting the stereoscopic image corresponding to the spatial information of the glasses unit 100 to provide the projected stereoscopic image to the glasses unit 100.

In step S610, the method may include extracting information about a position or a direction of the glasses unit 100 which is worn by a user to calculate spatial information of the glasses unit 100.

The glasses unit 100 may selectively utilize various types of sensors that can obtain the information about the position or the direction of the glasses unit 100. For example, the glasses unit 100 may obtain the information about the position or the direction of the glasses unit 100 using an acceleration sensor, a gyroscope sensor, a geomagnetic sensor, a depth map sensor, or an optical marker sensor.

Thus, the acceleration sensor, the gyroscope sensor, the geomagnetic sensor, the depth map sensor, or the optical marker sensor may be mounted in the glasses unit 100.

In addition, the spatial information of the glasses unit 100 may be calculated using the infrared camera 260 or the depth camera 270.

Thus, the spatial information of the glasses unit 100 may be calculated through the information about the position or the direction of the glasses unit 100. Here, the spatial information of the glasses unit 100 may refer to information about a position or a direction in which a user views an image through the glasses unit 100.

In step S620, the method may include generating a stereoscopic image corresponding to the spatial information of the glasses unit 100.

Specifically, the stereoscopic images may be generated so that different stereoscopic images may be viewed in accordance with positions or directions in which multiple users view the image, and for this, the information about the position or the direction of the glasses unit 100 obtained by the glasses unit 100 may be utilized in generation of the stereoscopic images.

FIG. 7 is a flowchart showing a method of generating stereoscopic images according to an embodiment of the present invention.

Referring to FIG. 7, the method of generating the stereoscopic image corresponding to spatial information of the glasses unit 100 will be described in more detail.

In step S621, the method may include extracting a projection parameter for generating the stereoscopic image corresponding to the spatial information of the glasses unit 100.

The method may include extracting the projection parameter that enables the stereoscopic image to be rendered in accordance with the spatial information of the glasses unit 100.

That is, the projection parameter may be a parameter that enables the projected stereoscopic image to be rendered differently for each region in accordance with the spatial information of the glasses unit 100.

In step S623, the method may include generating the stereoscopic image corresponding to the spatial information of the glasses unit 100 based on binocular disparity using the projection parameter.

The method may include generating the stereoscopic image by rendering the image using the projection parameter, and through this, the stereoscopic image generating unit 230 may generate the stereoscopic images that are rendered differently for each region in accordance with the spatial information of the glasses unit 100.

In step S625, the method may include correcting image distortion that occurs in accordance with the spatial information of the glasses unit 100.

Distortion of an image may occur in a process of rendering the image using the projection parameter, and the method may include correcting such distortion of the image.

For example, the method may include correcting the image through shader-based image warping.

In step S627, the method may include adjusting the stereoscopic image corresponding to the spatial information of the glasses unit 100 so as to match images between at least two of the glasses unit 100, the projector 310, and the display device 320 that implements the 3D image.

The stereoscopic image projected from the projector 310 may be transmitted to the user's eyes through the glasses unit 100, and the image provided by the display device 320 implementing the 3D image may be also provided to the user's eyes through the glasses unit 100, so that the images provided in this process are required to be matched.

Accordingly, the stereoscopic images may be adjusted so that images are matched between the user's eyes and the glasses unit 100, between the glasses unit 100 and the projector 310, and between the glasses unit 100 and the display device 320.

In step S630, the stereoscopic image corresponding to the spatial information of the glasses unit 100 may be projected, and the projected stereoscopic image may be provided to the glasses unit 100.

That is, the projector 310 may provide the stereoscopic image corresponding to the spatial information of the glasses unit 100 to a plurality of glasses units 100.

In addition, the projector 310 may be utilized simultaneously with the display device 320 that implements the 3D images.

That is, according to an embodiment of the present invention, the stereoscopic image corresponding to the spatial information of the glasses unit 100 may be projected using the projector 310, and at the same time, the 3D image may be provided to multiple users using the display device 320.

The system of providing the stereoscopic image to multiple users according to an embodiment of the present invention may provide the same visual effects as above to the multiple users without using expensive HMD equipment which is complex and failure-prone.

That is, according to the embodiments of the present invention, through lightweight glasses constituted of only simple optical elements such as the semi-transmission mirror 110, the polarization filter 120, and the like without a separate electronic device such as a micro panel, stereoscopic information such as through an existing HMD may be actively provided.

In addition, using the glasses unit 100 according to the embodiments of the present invention, a limited viewing angle generated when viewing a stereoscopic screen through a stationary 3D display device may be overcome, thereby enhancing immersion.

In particular, according to the embodiments of the present invention, stereoscopic images and augmented reality may be efficiently provided in exhibitions, theme parks, and the like in which multiple users gather.

While the example embodiments of the present invention and their advantages have been described in detail, it should be understood that various changes, substitutions, and alterations may be made herein without departing from the scope of the invention.

What is claimed is:

1. A system of providing a stereoscopic image to multiple users, comprising:
at least one glasses unit;
a stereoscopic image generating device configured to calculate spatial information of the at least one glasses unit, and generate the stereoscopic image corresponding to the spatial information of the at least one glasses unit; and
a stereoscopic image providing device configured to project the stereoscopic image corresponding to the spatial information of the at least one glasses unit to provide the projected stereoscopic image to the at least one glasses unit.

2. The system of claim 1, wherein the at least one glasses unit includes a semi-transmission mirror that semi-transmits and reflects the projected stereoscopic image, and a polarization filter that is mounted in a front surface of the semi-transmission mirror to reproduce a three-dimensional (3D) image.

3. The system of claim 1, wherein the at least one glasses unit generates information about a position or a direction of the at least one glasses unit using at least one of an acceleration sensor, a gyroscope sensor, a geomagnetic sensor, a depth map sensor, and an optical marker sensor to provide the generated information to the stereoscopic image generating device.

4. The system of claim 1, wherein the stereoscopic image generating device includes a glasses tracking unit that calculates the spatial information of the at least one glasses unit using information about a position or a direction of the at least one glasses unit, and a parameter extraction unit that extracts a projection parameter for generating the stereoscopic image corresponding to the spatial information of the at least one glasses unit.

5. The system of claim 4, wherein the glasses tracking unit calculates the spatial information of the at least one glasses unit using an infrared camera or a depth camera.

6. The system of claim 4, wherein the stereoscopic image generating device includes a stereoscopic image generating unit that generates the stereoscopic image corresponding to the spatial information of the at least one glasses unit using the projection parameter, and a distortion correction unit that corrects image distortion that occurs in accordance with the spatial information of the at least one glasses unit.

7. The system of claim 6, wherein the stereoscopic image providing device includes a projector that projects the stereoscopic image corresponding to the spatial information of the at least one glasses unit, and a display device that implements a 3D image.

8. The system of claim 7, wherein the stereoscopic image generating device further includes a calibration unit that adjusts the stereoscopic image corresponding to the spatial information of the at least one glasses unit so as to match images between at least two of the at least one glasses unit, the projector, and the display device that implements the 3D image.

9. A stereoscopic image generating device that provides a stereoscopic image to multiple users, comprising:
a glasses tracking unit configured to extract information about a position or a direction of at least one glasses unit to calculate spatial information of the at least one glasses unit;
a parameter extraction unit configured to extract a projection parameter for generating the stereoscopic image corresponding to the spatial information of the at least one glasses unit; and
a stereoscopic image generating unit configured to generate the stereoscopic image corresponding to the spatial information of the at least one glasses unit using the projection parameter.

10. The stereoscopic image generating device of claim 9, further comprising:
a distortion correction unit configured to correct image distortion that occurs in accordance with the spatial information of the at least one glasses unit.

11. The stereoscopic image generating device of claim 9, wherein the at least one glasses unit includes a semi-transmission mirror that semi-transmits and reflects a projected stereoscopic image, and a polarization filter that is mounted in a front surface of the semi-transmission mirror to reproduce a 3D image.

12. The stereoscopic image generating device of claim 9, wherein the stereoscopic image generating device transmits the stereoscopic image corresponding to the spatial information of the at least one glasses unit to a projector so that the transmitted stereoscopic image is projected.

13. A method of providing a stereoscopic image to multiple users, comprising:
extracting information about a position or a direction of at least one glasses unit which is worn by a user to calculate spatial information of the at least one glasses unit;
generating the stereoscopic image corresponding to the spatial information of the at least one glasses unit; and
projecting the stereoscopic image corresponding to the spatial information of the at least one glasses unit to provide the projected stereoscopic image to the at least one glasses unit.

14. The method of claim 13, wherein the at least one glasses unit includes a semi-transmission mirror that semi-transmits and reflects the projected stereoscopic image, and a polarization filter that is mounted in a front surface of the semi-transmission mirror to reproduce a 3D image.

15. The method of claim 13, wherein the extracting of the information includes extracting the information about the position or the direction of the at least one glasses unit using at least one of an acceleration sensor, a gyroscope sensor, a geomagnetic sensor, a depth map sensor, and an optical marker sensor which are mounted in the at least one glasses unit.

16. The method of claim 13, wherein the extracting of the information includes calculating the spatial information of the at least one glasses unit using an infrared camera or a depth camera.

17. The method of claim 13, wherein the generating of the stereoscopic image includes
extracting a projection parameter for generating the stereoscopic image corresponding to the spatial information of the at least one glasses unit,
generating the stereoscopic image corresponding to the spatial information of the at least one glasses unit using the projection parameter, and
correcting image distortion that occurs in accordance with the spatial information of the at least one glasses unit.

18. The method of claim 17, wherein the projecting of the stereoscopic image includes
projecting the stereoscopic image corresponding to the spatial information of the at least one glasses unit using a projector, and
providing a 3D image using a display device that implements the 3D image while projecting the stereoscopic image corresponding to the spatial information of the at least one glasses unit using the projector.

19. The method of claim 18, wherein the generating of the stereoscopic image further includes adjusting the stereoscopic image corresponding to the spatial information of the at least one glasses unit so as to match images between at least two of the at least one glasses unit, the projector, and the display device that implements the 3D image.

20. The method of claim 18, wherein the projector is a short focus projector.
